(19) United States
(12) Patent Application Publication
(10) Pub. No.: US 2016/0214365 A1
(43) Pub. Date: Jul. 28, 2016

(54) Method and Apparatus For Manufacturing Decorative Glass, Mirror and Other Substrates

(71) Applicant: iMagic Glass Inc., Concord, CA (US)

(72) Inventor: Vilius Garsva, Vaughan (CA)

(21) Appl. No.: 14/608,450

(22) Filed: Jan. 29, 2015

(30) Foreign Application Priority Data
Jan. 23, 2015 (CA) 2879471

(51) Int. Cl. B32B 38/00

(52) U.S. Cl. CPC B32B 38/145

(57) ABSTRACT

A method and apparatus for printing onto substrates, including glass and minor, uses ultraviolet-curable ink to print indicia onto the substrate. The method may be applied to a glass pane, for example for architectural glass, signage and other uses. After curing the ink the design is protected by laminating the pane. In the case of a mirrored pane the ultraviolet-curable ink serves as a ‘resist’ layer which allows the reflective surface to be selectively removed such that the remaining portions of the reflective layer form one or more designs or other indicia.

### CROSS REFERENCE TO RELATED APPLICATIONS

This application claims priority to Canadian Patent Application No. (to be assigned), filed Jan. 23, 2015, which is hereby incorporated by reference in its entirety.

### BACKGROUND OF THE INVENTION

1. Field of the Invention

This invention relates to a method and apparatus for creating decorative substrate sheets, including glass and mirrored panes.

2. Description of the Related Art

Decorative glass is used in many applications, one of the major applications being architectural glass used in buildings and other structures. For example, decorative glass window panes and dividers can be used for privacy, improving the aesthetic appearance of a building or premises; as signage conveying information; as decorative appointments to a room; and for myriad other purposes.

Printing on glass panes is becoming of the most popular means of customizing glass for privacy, aesthetics, signage and other uses. Conventionally printed glass is formed by applying a ceramic ink onto an annealed glass pane, for example by printing or screening techniques, which pane is then fired in a tempering furnace to cure the ink.

Conventional printing of multiple colours onto glass requires a multiple-step process, with each colour being deposited as a separate layer and dried before the next colour is applied, whether by screening or otherwise. This method is very time-consuming and labour-intensive, and commensurately expensive. Moreover, once the glass has been fired, the design is permanent and cannot be changed or over-printed.

Utilizing modern industrial inkjet printers, multiple colours can be deposited onto a substrate sheet such as a glass pane 2 during a single pass. For example, FIG. 1 illustrates a conventional sheet printer 10 for printing ceramic ink onto a glass pane 2. The printer has a planar work surface 12 comprising an infeed section 14 and an output section 16 preferably having conveying means such as rollers (not shown) so the pane 2 (or other substrate) can be moved along the work surface 12 without scratching. An example of a conventional printer suitable for such a process is a digital printer manufactured by Dip-tech Digital Printing Technologies Ltd. (for example as featured at http://www.dip-tech.com/digital_glass_printers) under the trademark Dip-Tech. A supporting rail 18 is mounted across the work surface between the infeed section 14 and the output section 16, raised sufficiently from the work surface 12 that the glass pane 2 can fit beneath it, and a printer shuttle 20 is in turn mounted onto the rail 18 so as to move back an forth across the work surface 12 as the pane 2 is fed beneath the rail 18. The printer shuttle 20 has a printer portion 20a containing inkjet print heads (not shown) filled with ceramic ink, controlled by a processor (not shown). As the printer shuttle 20 moves across the work surface 12 ink is deposited onto the glass pane 2 in successive lines until the printed design is completed.

There are a number of limitations to manufacturing decorative glass panes using the ceramic inks. Firing of the printed pane is necessary to cure the ceramic ink, so the conventional process necessarily results in a tempered glass pane as a substrate, which cannot be further processed in certain ways that annealed glass can be processed (for example cut) and is typically more expensive to laminate.

Moreover, any printing process utilizing ceramic ink cannot be used at all on minor, which has a reflective surface formed from sublayers of silver and copper, because these metallic layers will not survive the firing process. Decorative minor having reflective design elements is thus created by hand, for example using sandblasting to remove portions of the reflective layer which do not form part of the desired design, which is time-consuming and highly labour-intensive.

There is accordingly a need for a more efficient and versatile method and apparatus for applying designs and other indicia to glass substrates, particularly (but not limited to) glass and mirrored panes.

### SUMMARY OF THE INVENTION

According to one preferred and non-limiting embodiment, provided is a method of printing onto a cleaned surface to be printed of a glass pane having an air side and a tin side, using a printer apparatus having an infeed conveyor, an output conveyor and a digital inkjet printer there between stocked with ultraviolet-curable ink, the method comprising: a. applying an adhesion promoter onto the surface to be printed; b. allowing the adhesion promoter to dry; c. at any time before step d., positioning the pane on a printer infeed conveyor with the printed surface facing the printer; d. at any time before step e., programming a design with the desired indicia into the inkjet printer; e. feeding the pane past the inkjet printer to deposit ink onto the surface to be printed in the shape and colours of the desired indicia; f. curing the ink; g. in any order, removing the glass pane from the printer apparatus and allowing the ink to de-gas; h. laminating a laminate layer over the printed side of the pane; and i. injecting a curable resin between the laminate layer and the pane.

In one preferred and non-limiting embodiment, the surface to be printed is the air side of the pane.

In one preferred and non-limiting embodiment, step a. is performed using a silane-based adhesion promoter.

In one preferred and non-limiting embodiment, step e. is performed using a flexible ultraviolet ink.

In one preferred and non-limiting embodiment, step h. is performed using a glass laminate. Step h. may include: h1. applying a double-sided adhesion tape around the periphery of the printed pane; h2. adhering the laminating pane to the tape; and h3. filling a void between the glass pane and the glass laminate with a resin.

According to another preferred and non-limiting embodiment, provided is a method of creating reflective indicia on a mirror having a viewing surface opposite a reflective surface comprising a metallic reflective layer coated by a paint layer, the method comprising: a. removing at least a portion of the paint layer; b. applying an adhesion promoter onto the reflective layer exposed by step a.; c. allowing the adhesion promoter to dry; d. at any time before step e., positioning the pane on a printer infeed conveyor with the reflective layer facing the printer; e. at any time before step f., programming a design with the desired indicia into the inkjet printer; f. feeding the mirrored pane past the inkjet printer to deposit an ultraviolet-curable ink onto the reflective layer in the shape of the desired indicia; g. curing the ink; h. removing the paint from of the portions of the reflective surface that are not coated by the ink; and i. stripping the metallic layers off of the portions of the reflective surface that are not coated by the ink.

In one preferred and non-limiting embodiment, step b. is performed using a silane-based adhesion promoter.

In one preferred and non-limiting embodiment, step f. is performed using a flexible ultraviolet ink.

In one preferred and non-limiting embodiment, step h. is performed using a chemical stripper.

In one preferred and non-limiting embodiment, step h. is performed by physical abrasion.

In one preferred and non-limiting embodiment, the physical abrasion is effected by a blasting media.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

In drawings which illustrate by way of example only a preferred embodiment of the invention,

FIG. 1 is a schematic perspective view of a printing apparatus which may be used in the method of the invention;

FIG. 2 is a perspective view of a glass pane which can be used as a substrate for printing according to the invention;

FIG. 3 is an edge elevation of the pane of FIG. 2;

FIG. 4 is a perspective view of a printed glass pane taped for lamination;

FIG. 5 is a partial end cross-section of a printed, laminated and filled decorative pane of glass according to the invention;

FIG. 6 is a perspective view of a mirrored pane which can be used as a substrate for printing according to the invention;

FIG. 7 is an edge elevation of the mirrored pane of FIG. 6;

FIG. 8 is an enlarged partial end cross-section of the mirrored pane of FIG. 6;

FIG. 9 is a partial end cross-section of a printed, laminated and filled decorative pane of mirror according to the invention;

FIG. 10 is a partial end cross-section of a decorative doubled glass pane according to a further embodiment of the invention; and

FIG. 11 is a cross-sectional end elevation of a rail containing an ultraviolet curing station

### DETAILED DESCRIPTION OF THE INVENTION

For purposes of the description hereinafter, the terms “upper”, “lower”, “right”, “left”, “vertical”, “horizontal”, “top”, “bottom”, “lateral”, “longitudinal” and derivatives thereof shall relate to the invention as it is oriented in the drawing figures. It is to be understood that the invention may assume various alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

The present invention uses an ultraviolet-curable ink to print designs, indicia 1 onto a substrate sheet, for example a pane of glass or a mirrored pane. The term “sheet” as used herein includes panes, panels and other flat and generally planar substrates made from a material capable of withstanding the ultraviolet curing process. In one preferred and non-limiting embodiment, the method may be applied to a glass pane 2, which could for example (without limitation) be used as architectural glass, signage, decorative appointment, stained glass and in many other applications; and to a mirrored pane 30 which can have its reflective layer selectively removed to create reflective designs and other indicia from the remaining portions of the reflective layer (and/or printed with indicia or other matter in the same fashion as a glass pane 2).

According to one preferred and non-limiting embodiment of the method of the invention, firing of the finished product is unnecessary. This provides a number of advantages, including allowing the method to be used on mirror and on low-melting point substrates such as sheet vinyl. The method of the invention allows for extremely high resolution graphics (for example 1,500 dpi) and other visual matter, providing a greater array of colours and durability as conventional ceramic inks used on glass but with a wider array of substrates. When used on minor the invention allows for the creation of finely detailed reflective graphics and other indicia at a fraction of the labour and cost of conventional methods for removing the reflective layer to leave a reflective design or other indicia, although in the case of mirror the printer is used to print a “resist” layer which protects the reflective sublayers from a chemical remover which subsequently strips all the non-printed areas, which becomes clear (see-through) while the printed areas remain reflective and thus produce the desired design.

In preferred and non-limiting embodiments, an inkjet printing apparatus is utilized to apply the ultraviolet-curing ink to the glass, which takes advantage of the high resolution of digital printing techniques and, unlike silkscreened or hand painted techniques, allows for print gradients from solid to clear without banding.

The invention thus provides method of printing onto a cleaned surface to be printed of a glass pane having an air side and a tin side, using a printer apparatus having an infeed conveyor, an output conveyor and a digital inkjet printer there between stocked with ultraviolet-curable ink, comprising: a. applying an adhesion promoter onto the surface to be printed; b. allowing the adhesion promoter to dry; c. at any time before step d., positioning the pane on a printer infeed conveyor with the printed surface facing the printer; d. at any time before step e., programming a design with the desired indicia into the inkjet printer; e. feeding the pane past the inkjet printer to deposit ink onto the surface to be printed in the shape and colours of the desired indicia; f. curing the ink; g. in any order, removing the glass pane from the printer apparatus and allowing the ink to de-gas; h. laminating a laminate layer over the printed side of the pane; i. injecting a curable resin between the laminate layer and the pane.

In another preferred and non-limiting embodiment, the invention further provides a method of creating reflective indicia on a mirror having a viewing surface opposite a reflective surface comprising a metallic reflective layer coated by a paint layer, comprising the steps of: a. removing at least a portion of the paint layer; b. applying an adhesion promoter onto the reflective layer exposed by step a.; c. allowing the adhesion promoter to dry; d. at any time before step e., positioning the pane on a printer infeed conveyor with the reflective layer facing the printer; e. at any time before step f., programming a design with the desired indicia into the inkjet printer; f. feeding the mirrored pane past the inkjet printer to deposit an ultraviolet-curable ink onto the reflective layer in the shape of the desired indicia; g. curing the ink; h. removing the paint from of the portions of the reflective surface that are not coated by the ink; and i. stripping the metallic layers off of the portions of the reflective surface that are not coated by the ink.

### Decorative Glass Printing Method

The surface on which the ink will be applied should be thoroughly cleaned, for example utilizing a conventional glass degreaser such as Windex (Trademark) or any other suitable cleaner. Raw glass panes are formed by pouring molten glass onto a layer of molten tin. A glass pane 2 therefore has an “air” side 2a (the top surface during the forming process, which is exposed to the air) and a “tin” side 2b (the bottom surface during the forming process, which flows over the molten tin). The air side 2a of the pane 2 is invariably rougher than the tin side 2b, and therefore provides better adhesion, so the air side 2a is preferably used as the printing surface in the preferred embodiment.

Thus, in one preferred and non-limiting embodiment, the air side 2a of the pane 2 is cleaned and the glass pane 2 is positioned so that the air side 2a of the pane 2 is accessible. One preferred and non-limiting embodiment of the method of printing onto the glass pane according to the invention is as follows:

1. Applying an adhesion promoter onto the air side 2 of the pane, for example using a sprayer (not shown). This will improve the bond between the glass surface and the ultraviolet-curable ink. Adhesion promoters which work well in this application include most silane based products.

2. Allowing the adhesion promoter to dry. With a silane-based adhesion promoter this takes about 5 minutes at room temperature, depending upon ambient humidity conditions.

3. If the glass pane was not positioned on the printer infeed conveyor for steps 1. or 2., positioning the glass pane on the printer infeed conveyor with the air side 2a facing up, i.e. facing the inkjet printer heads in the printer 20a.

4. Programming the desired indicia into a computer having a suitable driver for the digital inkjet printer, which is stocked with ultraviolet-curable ink. This programming step may be performed at any time before printing begins. The indicia may comprise text, one or more graphics, and/or any other matter capable of being rendered as a 2-dimensional image, in any available colour. The ink may for example be a flexible UV ink, available from a number of manufacturers worldwide.

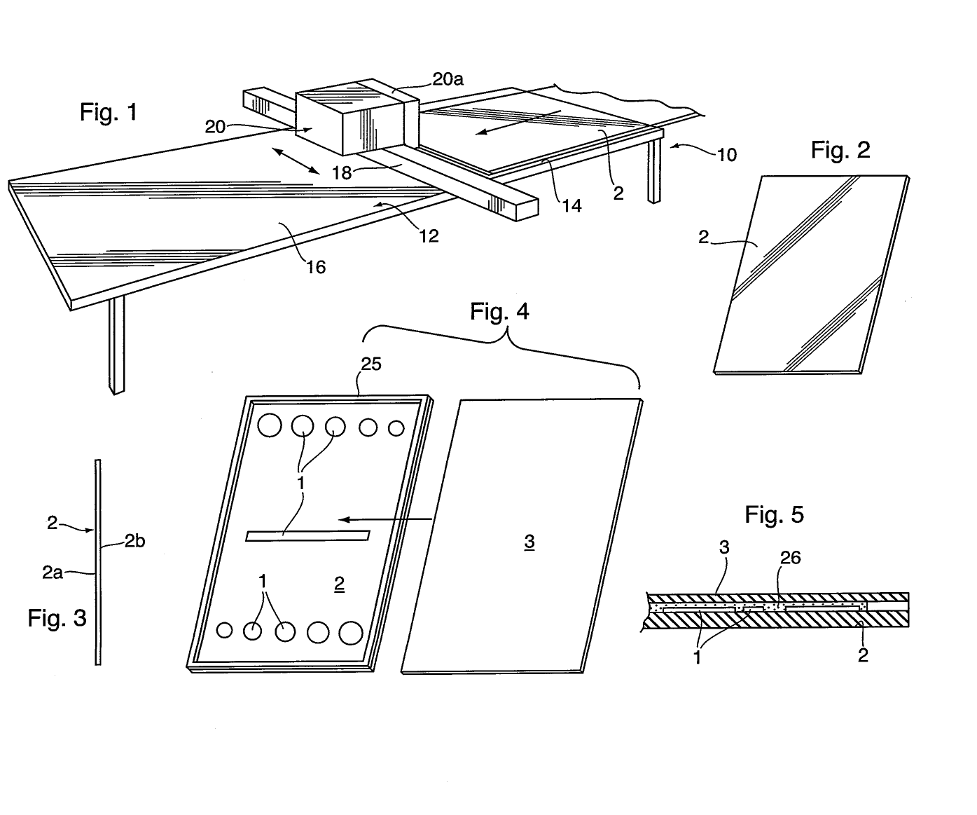

One example of a suitable printer is a conventional digital printer manufactured by Dip-tech Digital Printing Technologies Ltd. (for example as featured at http://www.dip-tech.com/digital_glass_printers). A printer of this type is currently used for printing ceramic inks which are cured in a firing kiln. The ultraviolet-curable inks used in the present invention require a short residence time exposed to ultraviolet light after the ink is deposited onto the printer apparatus, in order to cure the ink. In one embodiment the rail 18 on which the printer 20 shuttle travels in the prior art printer apparatus 10 illustrated in FIG. 1 is replaced by a rail 28 which is essentially an inverted ‘U’ in cross-section, and thus also serves as a mount (and optionally a reflector) for an ultraviolet curing stage downstream of the print heads, comprising ultraviolet LEDs 22 contained within the rail 28 and mounted to a base 24 serving as a raceway for the power supply wires (not shown), for example as illustrated in FIG. 11.

5. Feeding the pane 2 past the digital inkjet printer 20a. The ink is applied to the air side 2a of the pane 2 and cures under the ultraviolet lights 22 as the pane 2 egresses from the printer 20a and moves beneath the rail 28 onto the output conveyor 16.

6. Allowing the cured ink 1 to de-gas. In the preferred embodiments the glass pane 2 should be left undisturbed at room temperature for at least 24 hours to ensure complete de-gassing of the ink 1.

7. Protecting the cured ink 1, for example by laminating a glass laminate layer 3 over the printed side of the pane 2. This can be effected by, for example, applying a 1/16 inch silicon-based double-sided adhesion tape 25 around the periphery of the printed pane, as shown in FIG. 4, adhering the laminating pane 3 to the tape, and filling the void with a resin 26 such as polyester based resin (which intrudes into the air gap by capillary action), to seal and protect the cured design. Once the resin 26 has cured, the printed glass pane 2 is completed and ready to be installed. There are other suitable methods of laminating including more conventional processes such at PVB or EVA lamination whereby a film layer is applied over the printed image and the laminate is cured using heat and pressure.

Multi-layered designs can be created by printing designs onto the air side 2a of two separate glass panes 2, which may be (but are not necessarily) of the same thickness, and laminating the two printed panes 2 together with the printed surfaces facing each other, for example as in the double-pane embodiment illustrated in FIG. 10. The designs on the two panes 2 may be different to create a composite design. Alternatively, a design can be augmented by printing the design on one pane 2′ and printing a laterally inverted version of the same design on the second pane 2″, so that when laminated together with the printed surfaces (air sides 2a) facing each other the designs on the two panes 2′, 2″ coincide as shown in FIG. 10.

### Decorative Minor Printing Method

The invention is also particularly advantageously used in embodiments that utilize a mirrored pane 30 as a substrate. Because no firing is required to cure and seal the printed design, the invention can be used to print designs on minor utilizing not only the coloured ink stocked in the printer to create a design in the manner described above, but also using the ultraviolet-curable ink as a base step to selectively remove portions of the metallic reflective layer while preserving other portions of the reflective layer to form the design.

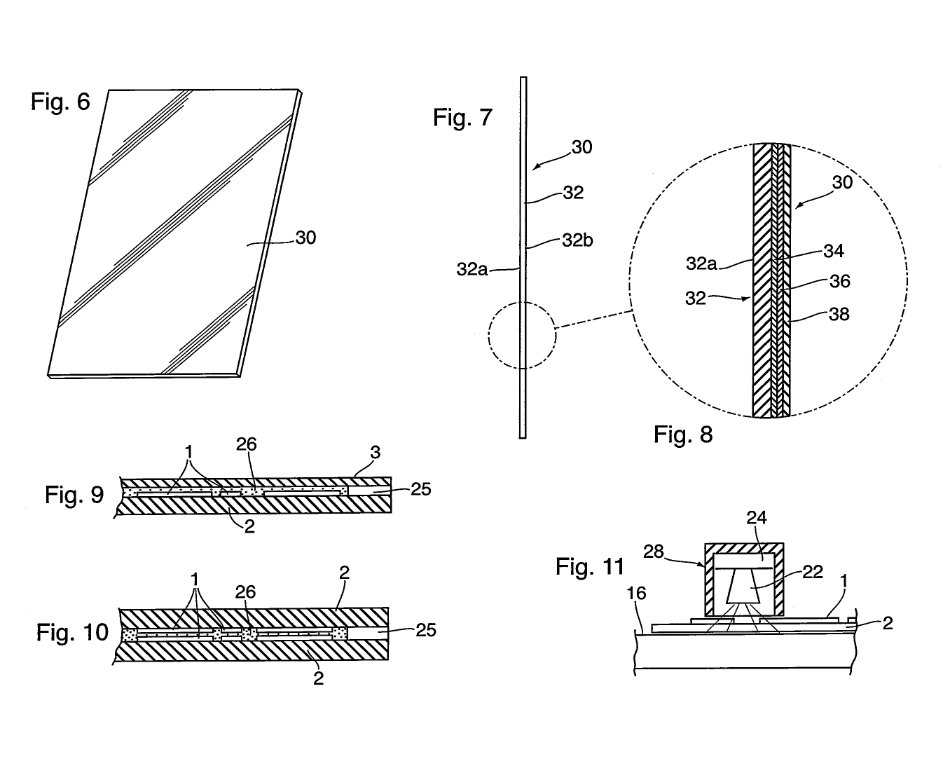

A typical mirror 30, illustrated in FIGS. 6 to 8, comprises a pane of glass 32 with a viewing surface 32a opposite a “painted” surface 32b which is made reflective by a metallic reflective layer applied over the glass. The reflective layer typically comprises a silver sublayer 34 covered by a protective copper sublayer 36; the copper sublayer 36 is in turn covered by a paint layer 38, which seals and protects the reflective metallic layer formed by sublayers 34 and 36.

The invention can be used to create a reflective design on the mirrored pane 30. In preferred and non-limiting embodiments, the steps are as follows:

1. Remove the protective layer of paint 38 from the painted surface 32b of the mirror 30.

2. Apply adhesion promoter to the surface 32b where the protective paint has been removed, over the silver/copper layers 34, 36). This may be accomplished, for example, by applying (for example, spraying) an adhesion promoter onto the copper layer 36. The adhesion promoter may be the same as that used in the above embodiments for printing onto glass panes 2.

3. Print UV ink onto the copper/silver surface to form a “resist” layer. In the embodiment illustrated the mirrored pane 30 is fed past the inkjet printer 20 with the reflective surface 32b of the mirrored pane 30 facing up (i.e. facing the ink jets in the printer 20a), to thus print ultraviolet-curable ink onto the reflective surface 32b of the minor 30 in a laterally inverted rendering of the desired design, and past the ultraviolet light curing stage.

4. Curing the ink. This is effected as described above, by the ultraviolet lights 22 in the printer apparatus 10.

5. Remove the silver/copper in areas not covered by UV ink. In the first method this is accomplished by chemical removal, using a suitable silver/copper remover such as “Silverstrip” (Trademark) manufactured by The Dow Chemical Company. In a variation of the method this step is accomplished by physical removal, using an etching process, for example a sandblasting technique using an abrasive blast media. In each case the “resist” layer formed by the ultraviolet ink prevents removal of the printed sections of the reflective surface.

6. After the required residence time, removing the copper-silver remover using a damp cloth which in turn removes the silver and copper residue from all unprinted areas of the reflective surface 32b, leaving the silver and copper sublayers 34, 36 intact underneath the “resist” layer formed by the cured ink 1, which is inert to the copper-silver remover so the printed design remains unaffected.

The result is a decorative minor having a reflective layer in the form of the design that was printed in ultraviolet-curable ink onto the reflective surface 32b of the mirrored pane 30, visible through the viewing surface 32a in a reflective minor finish.

Various embodiments of the present invention having been thus described in detail by way of example, it will be apparent to those skilled in the art that variations and modifications may be made without departing from the invention. The invention includes all such variations and modifications as fall within the scope of the appended claims. Further, it will be appreciated that the drawings are not necessarily to scale, and certain dimensions and relative proportions have been exaggerated for purposes of illustration. Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A method of printing onto a cleaned surface to be printed of a glass pane having an air side and a tin side, using a printer apparatus having an infeed conveyor, an output conveyor and a digital inkjet printer there between stocked with ultraviolet-curable ink, comprising:
a. applying an adhesion promoter onto the surface to be printed;
b. allowing the adhesion promoter to dry;
c. at any time before step d., positioning the pane on a printer infeed conveyor with the printed surface facing the printer;
d. at any time before step e., programming a design with the desired indicia into the inkjet printer;
e. feeding the pane past the inkjet printer to deposit ink onto the surface to be printed in the shape and colours of the desired indicia;
f. curing the ink;
g. in any order, removing the glass pane from the printer apparatus and allowing the ink to de-gas;
h. laminating a laminate layer over the printed side of the pane; and
i. injecting a curable resin between the laminate layer and the pane.

2. The method of claim 1, wherein the surface to be printed is the air side of the pane.

3. The method of claim 1, wherein step a. is performed using a silane-based adhesion promoter.

4. The method of claim 1, wherein step e. is performed using a flexible ultraviolet ink.

5. The method of claim 1, wherein step h. is performed using a glass laminate.

6. The method of claim 5, wherein step h. comprises:
h1. applying a double-sided adhesion tape around the periphery of the printed pane;
h2. adhering the laminating pane to the tape; and
h3. filling a void between the glass pane and the glass laminate with a resin.

7. A method of creating reflective indicia on a mirror having a viewing surface opposite a reflective surface comprising a metallic reflective layer coated by a paint layer, comprising:
a. removing at least a portion of the paint layer;
b. applying an adhesion promoter onto the reflective layer exposed by step a.;
c. allowing the adhesion promoter to dry;
d. at any time before step e., positioning the pane on a printer infeed conveyor with the reflective layer facing the printer;
e. at any time before step f., programming a design with the desired indicia into the inkjet printer;
f. feeding the mirrored pane past the inkjet printer to deposit an ultraviolet-curable ink onto the reflective layer in the shape of the desired indicia;
g. curing the ink;
h. removing the paint from of the portions of the reflective surface that are not coated by the ink; and
i. stripping the metallic layers off of the portions of the reflective surface that are not coated by the ink.

8. The method of claim 7, wherein step b. is performed using a silane-based adhesion promoter.

9. The method of claim 7, wherein step f. is performed using a flexible ultraviolet ink.

10. The method of claim 7, wherein step h. is performed using a chemical stripper.

11. The method of claim 7, wherein step h. is performed by physical abrasion.

12. The method of claim 11, wherein the physical abrasion is effected by a blasting media.
